(19) United States
(12) Patent Application Publication
(10) Pub. No.: US 2014/0028494 A1
(43) Pub. Date: Jan. 30, 2014

(54) Virtual Aperture Radar

(71) Applicants: David A. Ksienski, Los Angeles, CA (US); Samuel S. Osofsky, Rancho Palos Verdes, CA (US); Adam M. Chandler, Altadena, CA (US)

(72) Inventors: David A. Ksienski, Los Angeles, CA (US); Samuel S. Osofsky, Rancho Palos Verdes, CA (US); Adam M. Chandler, Altadena, CA (US)

(73) Assignee: THE AEROSPACE CORPORATION, El Segundo, CA (US)

(21) Appl. No.: 13/558,643

(22) Filed: Jul. 26, 2012

(51) Int. Cl. G01S 13/90

(52) U.S. Cl. 342/25 A

(57) ABSTRACT

A VAR system is disclosed. The VAR system may steer a beam to create an illusion of a moving aperture. As a result, a target may be illuminated at different angles to form an image. For example, the VAR system may include a transmission and receiving unit configured to steer a beam, such that a plurality of virtual aperture radars are created behind a reflector. The reflector may be configured to direct the beam to a target, and redirect a plurality of reflected beams from the target to the transmission and receiving unit.

### FIELD

The present invention relates to high-resolution radar imaging, and more particularly, to collecting a radar image by utilizing a passive reflector.

### BACKGROUND

A key issue facing public safety and security agencies is the detection of hidden weapons as people approach doorways of a public venue. Addressing this problem has become an important application of ground-based imaging radar systems. These systems typically utilize high radio frequencies (tens to hundreds of gigahertz, or “millimeter waves”) because of their ability to penetrate clothing. At high radio frequency, a person moving at a walking pace will move through one wavelength in just a few milliseconds. When imaging with these short wavelengths, a focused image requires either very short-duration collections (˜100 microseconds or less) or a cooperative, stationary target. To achieve high-resolution beams at high frequencies, meter-scale antennas generally require a subject to be within a few meters of the radar.

For example, a fielded millimeter-wave airport passenger scanner utilizes mechanically scanned antenna arrays. The individual being imaged must stand still for several seconds inside a booth while the sensor physically rotates around the subject. These systems are phase-coherent, and produce high-resolution three-dimensional imagery using synthetic aperture radar (SAR) or holographic techniques. However, these systems require a cooperative individual in close proximity to the imaging apparatus. Newer airport-class systems are capable of generating a two-dimensional image at a much faster rate, and can be used on an uncooperative individual, i.e., a moving target. However, this system still requires that the target individual be in close proximity to the sensor, e.g., within approximately 1 meter.

Other systems, such as fielded radar systems, use millimeter waves to detect improvised explosive devices on an individual located at a significant distance from the sensor, e.g., approximately 10 meters to 200 meters. Such systems include a millimeter-wave radar system centered at 73 gigahertz (GHz), a processing system, and a graphical user interface (GUI) to interface with a user. The system can operate on a cooperative or uncooperative individual, but cannot generate a high-resolution image of the individual, and includes a detection algorithm based on ratios of reflectivity amplitudes.

Other systems may operate at quasi-optical frequencies near 600 GHz. However, to perform scanning, the systems require relatively large reflectors and secondary scanning mechanisms. Given the wavelengths and requirements for mechanical position control of these systems, the system and the scanning elements are relatively fragile and sensitive to uncontrolled non-laboratory conditions. Also, the mechanical nature of the scanning is not fast enough to “freeze-frame” an uncooperative individual. Accordingly, an improved radar system may be beneficial.

### SUMMARY

Certain embodiments of the present invention may provide solutions to the problems and needs in the art that have not yet been fully identified, appreciated, or solved by current systems. For example, one or more embodiments of the present invention pertain to a passive reflector that allows a sensor to illuminate or view a target from a range of different aspect angles. This may improve the capabilities of a given radar system by enhancing resolution and/or standoff range while reducing or eliminating any need for moving the sensor.

In one embodiment, a system includes a transmission and receiving unit configured to electronically steer a beam, such that a plurality of virtual aperture radars are created behind a reflector. The reflector is configured to direct the beam to a target, and redirect a plurality of reflected beams from the target to the transmission and receiving unit.

In another embodiment, a system includes a transmitter and a reflector. The transmitter is configured to transmit a beam to a target, and the reflector is configured to produce a plurality of virtual aperture radars behind the reflector to redirect a plurality of beams from the target to a transmission and receiving unit.

In yet another embodiment, an apparatus includes a transmission and receiving unit that is configured to determine geometrical coordinates to ascertain a direction of transmission of a beam. The transmission and receiving unit is further configured to steer the beam, such that a plurality of virtual aperture radars are created behind a reflector.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 illustrates a VAR system, according to an embodiment of the present invention.

FIG. 2 illustrates a VAR system, according to an embodiment of the present invention.

FIG. 3 illustrates a VAR system geometry, according to an embodiment of the present invention.

FIG. 4 illustrates a block diagram of a control system for a VAR system, according to an embodiment of the present invention.

### DETAILED DESCRIPTION OF THE EMBODIMENTS

Embodiments of the present invention pertain to a system, apparatus and method for collecting a radar image. For example, a combination of radar, a target, and a passive reflector may be utilized to create one or more virtual aperture radars behind the passive reflector. This passive reflector may be a curved or faceted reflector depending on the geometry required for the particular application.

It should be appreciated that the VAR system may mimic any conventional type of radar collection geometry, e.g., synthetic aperture radar, real aperture radar, etc. The VAR system can be used in a variety of radar applications to increase resolution or range, to reduce the physical scale of required radar hardware, or to reduce required movement of the system.

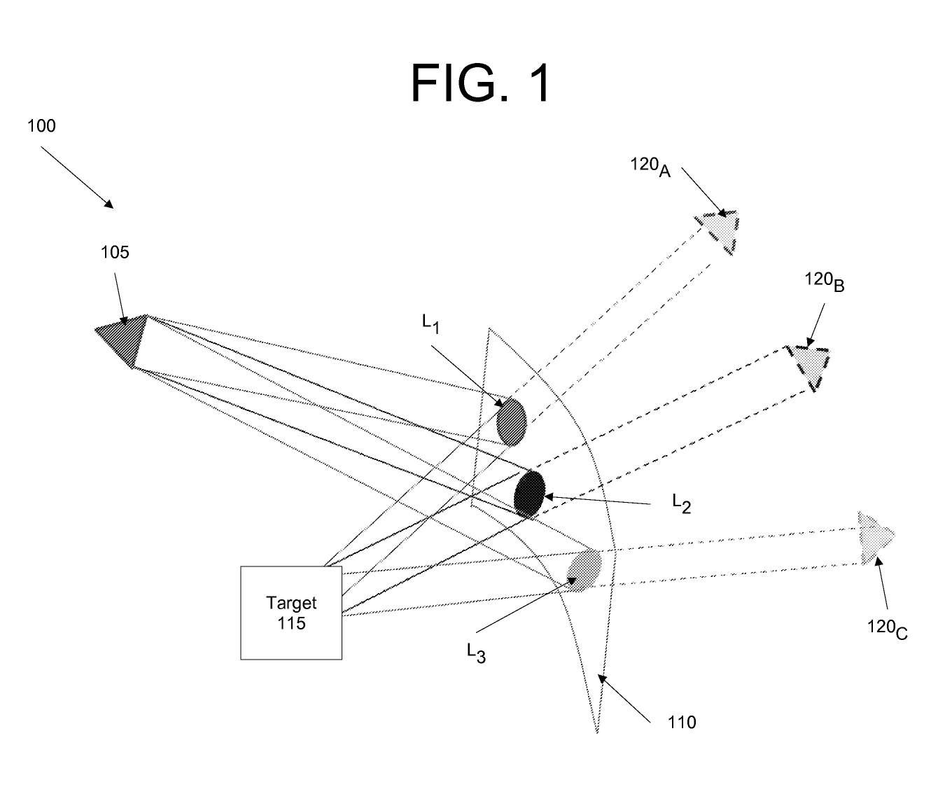

FIG. 1, for example, illustrates a VAR system 100, according to an embodiment of the present invention. VAR system 100 includes a transmission and receiving unit 105, a reflector or mirror 110, a stationary or moving target 115, and a plurality of virtual aperture locations 120_{A}, 120_{B}, 120_{C}. Transmission and receiving unit 105 may be a radar employing a single antenna or a plurality of antennas, or any other transmission and/or receiving mechanism that would be readily appreciated by a person of ordinary skill in the art. It should be appreciated that a phased array may allow single-pulse, near-instantaneous operation, but a single-channel system may also be employed with a stationary target, such as in a laboratory setting or with a cooperative target.

It should be appreciated that any number of virtual aperture locations may be used or created in some embodiments. The location of transmission and receiving unit 105 and reflector 110 relative to target 115, as well as the location of transmission and receiving unit 105 and reflector 110, may be based on a particular scenario or area, e.g., an airport, a stadium, etc.

Reflector 110 may include microwave reflectors constructed of relatively lightweight mesh and disguised as “art” and/or hidden behind radar-transparent, but optically opaque, material. It should be appreciated that the term “microwave” may mean any radio frequency. Reflector 110 (or a reflector system) may be one contiguous, continuously differentiable surface. In an alternative embodiment, reflector 110 may be piecewise continuous (i.e., contiguous, but not continuously differentiable). The individual sections including the otherwise contiguous reflector may be flat or curved. In some embodiments, a compound, discontinuous reflector including a plurality of segments may be used. The segments making up a discontinuous reflector may be flat or curved, and may be piecewise continuous themselves.

While some embodiments utilize a static, non-moving reflector, other embodiments may utilize a moving reflector that may move and/or rotate in any direction. It should be appreciated that a compound reflector system may be differentially translated and/or rotated.

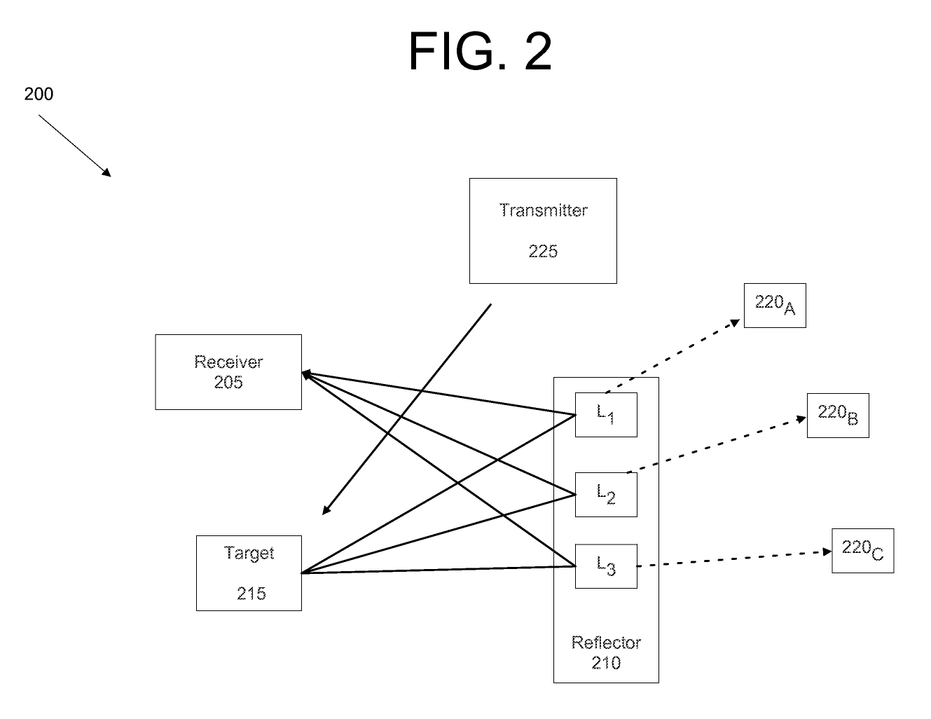

Transmission and receiving unit 105 may be operated mono-statically or bi-statically. See FIG. 2 for an example of bi-static operation. For example, in the case of mono-static operation, for each element on a phased array (e.g., transmission and receiving unit 105), the individual phases may be adjusted to form a beam in the direction of interest. The phased array may then transmit a single beam to a reflector 110, or to one of a plurality of reflectors (not shown). In this embodiment, a phased array may transmit a single beam to a first location L₁, a second location L₂, a third location L₃, or any location on reflector 110. It should be appreciated that there may be any number of locations on reflector 110 in some embodiments for a corresponding number of virtual aperture locations. A person of ordinary skill in the art will readily appreciate that the beams may be transmitted in any sequence or succession. For example, a first beam may be transmitted to reflector 110, then a second beam may be transmitted to reflector 110, and so on. The transmitted waveform may be a short pulse signal, a chirp signal, a chaotic signal, a continuous wave signal, or any modulated or non-modulated signal that would be appreciated by a person of ordinary skill in the art.

To determine which location the beam is to be transmitted to, transmission and receiving unit 105 may determine a location on target 115, a speed of target 115 if it is moving, a location of reflector 110, attributes of reflector 110, or any combination thereof. Attributes may include the degree of curvature of reflector 110, the angle of reflector 110, or any attribute that would be readily appreciated by a person of ordinary skill in the art. Based on this determination, transmission and receiving unit 105 may adjust a direction of transmission of the beam. For example, a phased array transmission and receiving unit 105 may be electronically steered (e.g., the beam can be aimed by time or phase-delaying the individual signals from the array elements), such that the beam is transmitted to the desired location on reflector 110.

It should be appreciated that transmission and receiving unit 105 may also be mechanically steered (e.g., physically pointing to different directions). Mechanical steering can be performed, for example, with single antennas or with phased array antennas. In bi-static systems, either mechanical or electronic steering may be used for either of the antenna systems (e.g., transmit or receive), including mechanically steering a transmitter with an electronically steered receiver. In some embodiments, a phased array could be simultaneously mechanically and electronically steered. In any case, steering could be in one dimension (e.g., azimuth only) or two dimensions (e.g., elevation and azimuth).

It should also be appreciated that transmission and receiving unit 105 may be placed at a fixed location or may be moved to different locations. Such a configuration may be applied to mono-static operation of transmission and receiving unit 105 or to a bi-static configuration employing separate transmission and receiving units (e.g., transmitter 225 and receiver 205 in FIG. 2). Because transmission and receiving unit 105 can be steered and moved, a virtual antenna can be made to move farther (or equivalently, faster) than a real antenna.

Depending on where the beam was directed to impinge on reflector 110, the beam is redirected by reflector 110 to target 115. It should be appreciated that reflector 110 may be a curved reflector, an angled reflector, or any combination thereof. For example, if transmission and receiving unit 105 transmits the beam to location L₁ on reflector 110, location L₁ may redirect the beam to target 115. Some of the beam energy may then bounce back, or reflect off of target 115 back to location L₁. Location L₁ may then redirect the reflected beam to transmission and receiving unit 105. This process could be repeated sequentially (using locations L₂, L₃, etc.) to collect a plurality of views of target 115.

In certain embodiments, the beam may bounce back, or reflect off of target 115 to a plurality of locations L₁, L₂, L₃, etc. Each location L₁, L₂, L₃ may simultaneously transmit the reflected beam to transmission and receiving unit 105 for processing the received beam(s) into an image. For example, simultaneous data streams from individual receive elements of a phased array antenna system may be split and processed using back-end electronics, or digitized, stored, and combined in software by a processing unit. In this way, a plurality of received beams can be electronically steered post-collection, using only a single transmit pulse. These beams can then be processed to produce an image of the target using standard image formation processing algorithms familiar to anyone skilled in the art. The image may be updated at a video rate of 30 times a second, for example. This allows the image to be overlaid with a video image of the moving target or person. If the image is of a person, then the image may be a nude image, a partially nude image, or any type of image illuminating an object, such as an improvised explosive device, a weapon, etc.

In certain embodiments of VAR system 100, real antennas transmit and/or receive signals that are redirected by an intermediate reflector. A given point in the target will “see” a reflection of a real antenna that appears to be located behind the reflector (thus, the use of the optical term “virtual”). VAR systems 100 can be used to generate any radar imagery that could have been produced with real antennas at the virtual antenna locations.

Moreover, VAR system 100 may collect image data by scanning a number of beams through a target volume at various aspect angles. Imagery may represent reflectivity as a function of scan position as well as reflectivity as a function of range. VAR system 100 may generate two or three-dimensional imagery by any image formation method used by those skilled in the art to process standard (real) radar data. For example, a VAR system can collect two-dimensional range-azimuth imagery, two-dimensional elevation-azimuth imagery, or three-dimensional range-elevation-azimuth imagery.

FIG. 2 illustrates a VAR system 200, according to an embodiment of the present invention. In this embodiment, bi-static operation may be performed using transmitter 225 to transmit a beam directly to target 215. Multiple beams may then reflect back from, or bounce off of, target 215 to reflector 210. Each location L₁, L₂, L₃ redirects the reflected energy to receiver 205. In certain embodiments, receiver 205 may be a transmission and receiving unit depending on design choice. FIG. 2 also depicts virtual receive apertures 220A, 220B, 220C behind reflector 210. As mentioned above, the reflected beams may be received simultaneously or sequentially by receiver 205 for subsequent image processing. It should be appreciated that transmitter 225 may include a single antenna or an array of antennas. Similarly, receiver 205 may include a single antenna or an array of antennas. Transmitter 225 may be fixed, mechanically steered, or electronically steered. Similarly, receiver 205 may employ mechanical or electronic steering. If receiver 205 is a phased array, then ex-post facto beam steering may be possible, allowing single-pulse operation. Factors, such as the relative placement of transmitter 225, receiver 205, reflector 210, and target 215, as well as the shape of reflector 210 can be tailored for a given implementation. However, it should be appreciated that the factors listed above are not intended to limit the scope of the embodiments, and other factors that would be appreciated by a person of ordinary skill in the art may be used.

It should be appreciated that many other bi-static embodiments are possible. In one embodiment, the transmitted signal may be bounced off reflector 210 prior to illuminating the target, rather than illuminating the target directly as shown in FIG. 2. In another embodiment, a plurality of transmitted beams may be transmitted to target 215 via reflector 210, to be received by a static, direct-path receiver. Bi-static configurations may utilize any combination of a single or an array of antennas, mechanical or electronic steering, and static or moving antennas, provided the reflector is used in at least one of the signal paths to or from the target (i.e., the transmit and/or receive path) to generate multiple virtual apertures.

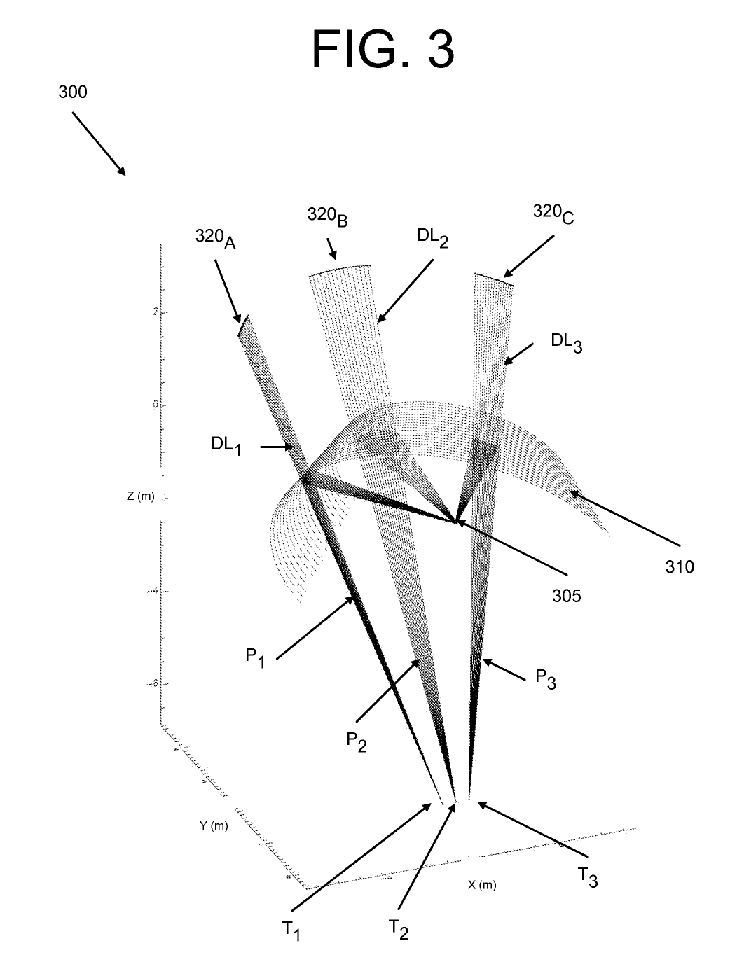

FIG. 3 illustrates a VAR system geometry 300, according to an embodiment of the present invention. In this embodiment, a conical reflector 310 is located above a roughly coaxial target region below. Three example target points T₁, T₂, T₃ are shown in FIG. 3. A linear antenna array 305 may be located near and perpendicular to the axis of the cone (along the x-direction in FIG. 3), above the target (at the height of reflector 310). Antenna element 305 may transmit a wide-beam radar pulse towards reflector 310. The pulse travels from reflector 310 to target. Return echoes from the target bounce off reflector 310 and are received by antenna array 305. P₁, P₂, P₃ indicate ray paths from individual elements of antenna array 305 to each of the three fiducial target points T₁, T₂, T₃. Dotted lines DL₁, DL₂, DL₃ show the extensions of the ray paths P₁, P₂, P₃ behind reflector 310 to the locations of virtual apertures 320_{A}, 320_{B}, 320_{C} seen from the three chosen target points T₁, T₂, T₃, respectively. This system generates near-instantaneous (i.e., single-pulse) range-azimuth imagery by recording and processing the individual element received signals. Azimuth resolution results from electronically steering a beam across the target region in software by appropriately delaying and adding the individual element signals. The curvature of the reflector results in virtual apertures 320_{A}, 320_{B}, 320_{C} that are significantly larger than real antenna array 305, thus providing a significant gain in resolution.

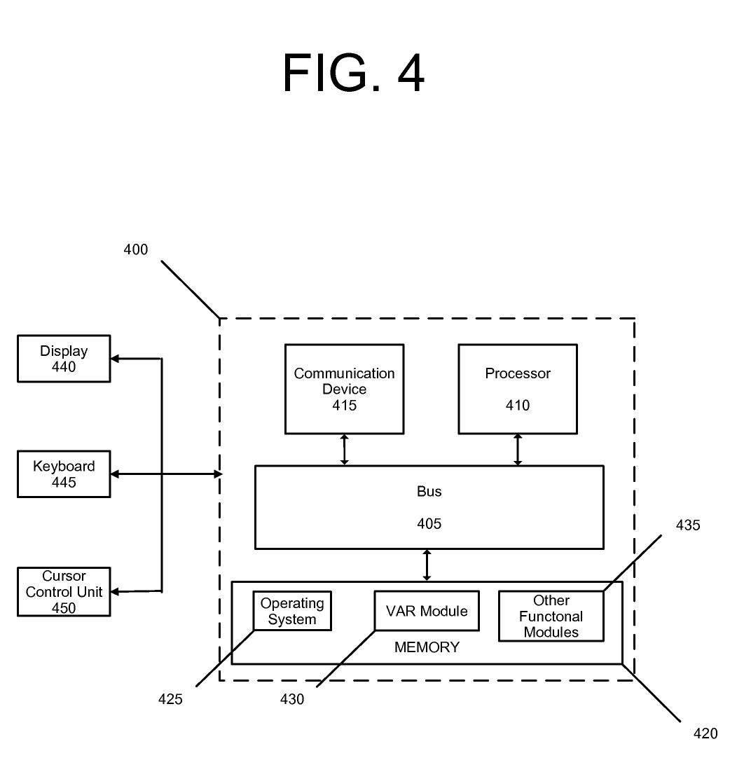

FIG. 4 illustrates a block diagram of a control system 400 for a VAR, according to an embodiment of the present invention. System 400 may include a bus 405 or other communication mechanism that can communicate information and a processor 410, coupled to bus 405, that can process information. Processor 410 can be any type of general or specific purpose processor. System 400 may also include memory 420 that can store information and instructions to be executed by processor 410. Memory 420 can be comprised of any combination of random access memory (“RAM”), read only memory (“ROM”), static storage such as a magnetic or optical disk, or any other type of computer readable medium. System 400 may also include a communication device 415, such as a network interface card, that may provide access to a network.

The computer readable medium may be any available media that can be accessed by processor 410. The computer readable medium may include both volatile and nonvolatile medium, removable and non-removable media, and communication media. The communication media may include computer readable instructions, data structures, program modules, or other data and may include any information delivery media.

Processor 410 can also be coupled via bus 405 to a display 440, such as a Liquid Crystal Display (“LCD”). Display 440 may display information to the user, such as a video image of the moving target. A keyboard 445 and a cursor control unit 450, such as a computer mouse, may also be coupled to bus 405 to enable the user to interface with system 400.

According to one embodiment, memory 420 may store software modules that may provide functionality when executed by processor 410. The modules can include an operating system 425 and a VAR module 430, as well as other functional modules 435. Operating system 425 may provide operating system functionality for system 400. VAR module 430 may be configured to cause processor 410 to steer a transmission and receiving unit such that a beam can be transmitted to, and received from, the target. Because system 400 may be part of a larger system, system 400 may include one or more additional functional modules 435 to include the additional functionality.

One skilled in the art will appreciate that a “system” could be embodied as a personal computer, a server, a console, a personal digital assistant (PDA), a cell phone, a tablet computing device, or any other suitable computing device, or combination of devices. Presenting the above-described functions as being performed by a “system” is not intended to limit the scope of the present invention in any way, but is intended to provide one example of many embodiments of the present invention. Indeed, methods, systems and apparatuses disclosed herein may be implemented in localized and distributed forms consistent with computing technology.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

One or more embodiments of the present invention allow for a virtual antenna to function as though it is a larger real antenna, creating a more narrow beam on the target, and therefore, better resolution for a given radar hardware system. In a conventional real aperture radar (RAR) collection, resolution degrades with range as the beam footprint increases. With a focusing VAR reflector, however, range is not a limiting factor per se. VAR standoff distance may be limited only by physical constraints on the size of the intermediate reflector, and available transmit power. As with conventional RAR, VAR can be used for two-dimensional elevation-azimuth scanning or range-azimuth (slant plane) imaging, or three-dimensional range-elevation-azimuth imaging.

The VAR system described herein may be used in a variety of radar applications to increase resolution (or maintain resolution at increased range), to reduce the physical scale of required radar hardware, or to reduce required movement. Microwave reflectors may be constructed of relatively lightweight mesh and disguised as “art” and/or hidden behind radar-transparent (but optically-opaque) material. There is considerable freedom and/or flexibility in the possible radar/reflector configurations in a VAR system. For example, the locations of the radar and reflector relative to the target area and to each other can be chosen to suit a particular scenario.

One or more embodiments of the present invention pertain to a VAR system that may include a phased array configured to electronically steer a beam, such that a plurality of virtual aperture radars are created behind a reflector. The reflector is configured to direct the beam to a target, and redirect a plurality of reflected beams from the target to the phased array.

The embodiments described herein have generally been exposited in relation to typical radar applications, assuming active illumination with electromagnetic wavelengths in the meter to millimeter range. The VAR paradigm may be applied to passive microwave collection (as described in any of the embodiments above involving virtual receive apertures, but without a transmitter). Additionally, the basic VAR model could be embodied with other electromagnetic wavelengths (e.g., LIDAR), as well as other mechanical wave phenomena, including acoustic waves. As such, the virtual aperture concept could be used in acoustic location (e.g., sonar, sonography), with the previously described microwave antennas replaced by appropriate transducers.

It will be readily understood that the components of the invention, as generally described and illustrated in the figures herein, may be arranged and designed in a wide variety of different configurations. Thus, the detailed description of the embodiments is not intended to limit the scope of the invention as claimed, but is merely representative of selected embodiments of the invention.

The features, structures, or characteristics of the invention described throughout this specification may be combined in any suitable manner in one or more embodiments. For example, the usage of “certain embodiments,” “some embodiments,” or other similar language, throughout this specification refers to the fact that a particular feature, structure, or characteristic described in connection with an embodiment may be included in at least one embodiment of the invention. Thus, appearances of the phrases “in certain embodiments,” “in some embodiments,” “in other embodiments,” or other similar language, throughout this specification do not necessarily all refer to the same embodiment or group of embodiments, and the described features, structures, or characteristics may be combined in any suitable manner in one or more embodiments.

One having ordinary skill in the art will readily understand that the invention as discussed herein may be practiced with steps in a different order, and/or with hardware elements in configurations that are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A system, comprising:
a transmitting and receiving unit configured to steer a beam, such that a plurality of virtual aperture radars are created behind a reflector, wherein
the reflector is configured to redirect the beam to a target, and redirect a plurality of reflected beams from the target to the transmission and receiving unit.

2. The system of claim 1, wherein the reflector comprises a continuous reflector, a piecewise continuous reflector, a plurality of discontinuous reflectors, or any combination of the continuous reflector, the piecewise continuous reflector, and the plurality of discontinuous reflectors.

3. The system of claim 1, wherein the reflector comprises a static reflector or a movable reflector.

4. The system of claim 1, wherein the transmitting and receiving unit comprises a static transmitting and receiving unit or a movable transmitting and receiving unit.

5. The system of claim 1, wherein the target comprises a moving target or a static target.

6. The system of claim 1, wherein the transmitting and receiving unit is further configured to determine a location of the target, a speed of the target, a location of the reflector, attributes of the reflector, or a combination thereof, prior to transmitting the beam to the target.

7. The system of claim 6, wherein the transmitting and receiving unit is further configured to adjust a direction of transmission of the beam based on the determined location of the target, the speed of the target, the location of the mirror, the attributes of the reflector, or a combination thereof.

8. The system of claim 1, wherein the transmission and receiving unit is further configured to transmit the beam to a location on the reflector, such that the beam is redirected to the target.

9. The system of claim 1, wherein a plurality of locations on the reflector are configured to redirect the plurality of reflected beams from the target to the transmission and receiving unit.

10. The system of claim 1, further comprising:
a processing unit configured to process the received plurality of reflected beams to generate a three-dimensional image of the target.

11. The system of claim 1, wherein the beam comprises a chirp signal, a chaotic signal, a continuous wave signal, short pulses, modulated pulses, or non-modulated pulses.

12. The system of claim 1, further comprising:
a transmitter configured to transmit a beam to the target, such that the beam, upon contact with the target, is split into a plurality of reflected beams moving towards a plurality of locations on the reflector.

13. The system of claim 12, wherein the transmitter is further configured to transmit the beam directly to the target.

14. The system of claim 12, wherein the transmitter is further configured to transmit the beam to the target using at least one reflector.

15. The system of claim 12, wherein each location on the reflector is configured to redirect a corresponding reflected beam to the transmission and receiving unit.

16. A system, comprising:
a transmitter configured to transmit a beam to a target; and
a reflector configured to produce a plurality of virtual aperture radars behind the reflector to redirect a plurality of beams produced by the target to a transmission and receiving unit.

17. The system of claim 16, wherein the reflector comprises a curved surface, such that each location on the reflector is configured to redirect a corresponding reflected beam from the target to the transmission and receiving unit.

18. The system of claim 16, wherein each location on the reflector is configured to act as a virtual aperture radar.

19. The system of claim 16, wherein the transmission and receiving unit is configured to receive each of the plurality of beams simultaneously.

20. The system of claim 16, wherein, when the beam from the transmitter contacts the target, the plurality of beams are produced by the target.

21. An apparatus, comprising:
a transmission and receiving unit configured to determine geometrical coordinates to ascertain a direction of transmission of a beam, and to steer the beam, such that a plurality of virtual aperture radars are created behind a reflector.

22. The apparatus of claim 21, wherein the transmission and receiving unit is further configured to transmit the beam to a location on a reflector, such that the reflector redirects the beam to a target.

23. The apparatus of claim 22, wherein the beam is configured to bounce off of the target into a plurality of beams.

24. The apparatus of claim 23, wherein the transmission and receiving unit is further configured to receive the plurality of beams from the target via different locations on the reflector.

25. The apparatus of claim 21, wherein the geometrical coordinates are based on a location of the target, a speed of the target, a location of the reflector, attributes of the reflector, or a combination thereof.
